(19) United States
(12) Patent Application Publication
(10) Pub. No.: US 2010/0195254 A1
(43) Pub. Date: Aug. 5, 2010

(54) OVERCURRENT AND BROWN OUT PROTECTION APPARATUS

(75) Inventors: Isaac Cohen, Dix Hills, NY (US); Richard Lee Valley, Nashua, NH (US); Michael Thomas Madigan, Cary, NC (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/364,226

(22) Filed: Feb. 2, 2009

(51) Int. Cl. H02H 9/00

(52) U.S. Cl. 361/18

(57) ABSTRACT

A discontinuous conduction mode (DCM) converter is provided. The converter comprises a transformer having a primary and a secondary side, an RCD network, a rectifier, a switch, and a controller. The transformer has primary side with a first primary winding and a second primary winding and has a secondary side with a secondary winding. The RCD network is coupled to the first primary winding and is adapted to receive energy from the leakage inductance of the first primary winding. The rectifier is coupled to the second primary winding. The switch is coupled between the RCD network and ground. The controller receives indicia of a rectified voltage from the rectifier, indicia of current from the switch, indicia of transformer magnetization and controls the actuation of the switch. Preferably, the controller provides an actuation signal to the switch with actuation periods that are separated from one another by an interval that allows energy within the transformer to substantially dissipate. Average output current of this converter is generally limited from the peak switch current level that is allowed by the controller and a switching frequency that the controller allows the converter to operate.

### TECHNICAL FIELD

The invention relates generally to power conversion and, more particularly, to overcurrent and brown out protection for a flyback converter.

### BACKGROUND

Power converters are in common use, and in particular, flyback converters are in common use. Additionally, flyback converters can operate in continuous conduction mode or CCM, discontinuous conduction mode or DCM or quasi-resonant mode. However, such CCM converters and quasi-resonant converters have over-current and brown out issues, especially under short circuit conditions. Some examples of conventional converters are: PCT Publication Nos. WO2008/097305; and WO2007/0039671; U.S. Patent Pre-Grant Publication Nos. 2008/0239764; 2008/0239762; and 2008/0192514; U.S. Pat. Nos. 7,443,700; 7,411,374; 7,262,977; Langeslag et al., “VLSI Design and Application of a High-Voltage-Compatible SoC-ASIC in Bipolar CMOS/DMOS Technology for AC-DC Rectifiers,” IEEE Transactions on Industrial Electronics, Vol. 54, No. 5, October 2007; and Data Sheet for AN1326.

### SUMMARY

A preferred embodiment of the present invention, accordingly, provides an apparatus. The apparatus comprises a transformer having a primary and a secondary side, wherein the primary side has a first primary winding and a second primary winding, and wherein the secondary side has a secondary winding; an RCD network coupled to the first primary winding; a rectifier coupled to the second primary winding; a measuring circuit coupled to ground; a switch coupled between the the first primary winding and the measuring circuit, wherein the measuring is adapted to measure current through the switch; and a controller that receives indicia of a rectified voltage from the rectifier and that controls the actuation of the switch, wherein the controller provides an actuation signal to the switch with actuation periods that are separated from one another by an interval that allows energy within the transformer to substantially dissipate.

In accordance with an embodiment of the present invention, the RCD network further comprises a capacitor coupled to a first terminal of the first primary winding; a diode coupled to the capacitor; and a resistor coupled to the first terminal and a node between the capacitor and diode.

In accordance with an embodiment of the present invention, the rectifier further comprises a diode coupled to the second primary winding; and a capacitor coupled between the diode and a common connection on the primary side.

In accordance with an embodiment of the present invention, the apparatus further comprises a second measuring circuit that is coupled to the rectifier and that provide the indicia of the rectified voltage to the controller.

In accordance with an embodiment of the present invention, the apparatus further comprises a second measuring circuit that is coupled across the second primary winding and that is adapted to provide an indicia of voltage across the second primary winding to the controller.

In accordance with an embodiment of the present invention, the apparatus further comprises a second rectifier coupled to the secondary winding of the secondary side, wherein the second rectifier outputs an output voltage and an output current.

In accordance with an embodiment of the present invention, the interval is greater than a sum of a period of decay of the output current and a resonance period.

In accordance with an embodiment of the present invention, an apparatus is provided. The apparatus comprises a first inductor having a first number of turns; a second inductor having a second number of turns, wherein the second inductor is adapted to be magnetically coupled to the first inductor; a third inductor having a third number of turns, wherein the third inductor is adapted to be magnetically coupled to the first and the second inductors; a capacitor coupled to a first terminal of the first inductor; a diode coupled between a second terminal of the first inductor and the capacitor; a resistor coupled to the first terminal of the first inductor and a node between the capacitor and diode; a rectifier coupled to the second inductor; a measuring circuit coupled to ground; a FET coupled between the first inductor and the measuring circuit; and a controller that receives indicia of a rectified voltage from the rectifier and that controls the actuation of the switch, wherein the controller provides an actuation signal to the switch with actuation periods that are separated from one another by an interval that allows energy within the first, second, and third inductors to substantially dissipate.

In accordance with an embodiment of the present invention, an apparatus is provided. The apparatus comprises a transformer having a primary and a secondary side, wherein the primary side has a first primary winding and a second primary winding, and wherein the secondary side has a secondary winding; an RCD network coupled to the first primary winding; a rectifier coupled to the second primary winding; a measuring circuit coupled to a common connection on the primary side; a switch coupled between the the first primary winding and the measuring circuit, wherein the measuring is adapted to measure current through the switch; and means for receiving indicia of a rectified voltage from the rectifier; and means for actuating the switch, wherein the means for actuating actuates the switch during periods that are separated from one another by an interval that allows energy within the transformer to substantially dissipate.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a flyback converter that operates in discontinuous conduction mode (DCM) converter in accordance with an embodiment of the present invention;

FIG. 2 is a timing diagram of the operation of the converter of FIG. 1;

FIG. 3 is an example configuration for the controller of FIG. 1;

FIG. 4 is another example configuration for the controller of FIG. 1; and

FIG. 5 is a timing diagram of the operation of the oscillator of the controller in FIG. 4.

### DETAILED DESCRIPTION

Refer now to the drawings wherein depicted elements are, for the sake of clarity, not necessarily shown to scale and wherein like or similar elements are designated by the same reference numeral through the several views.

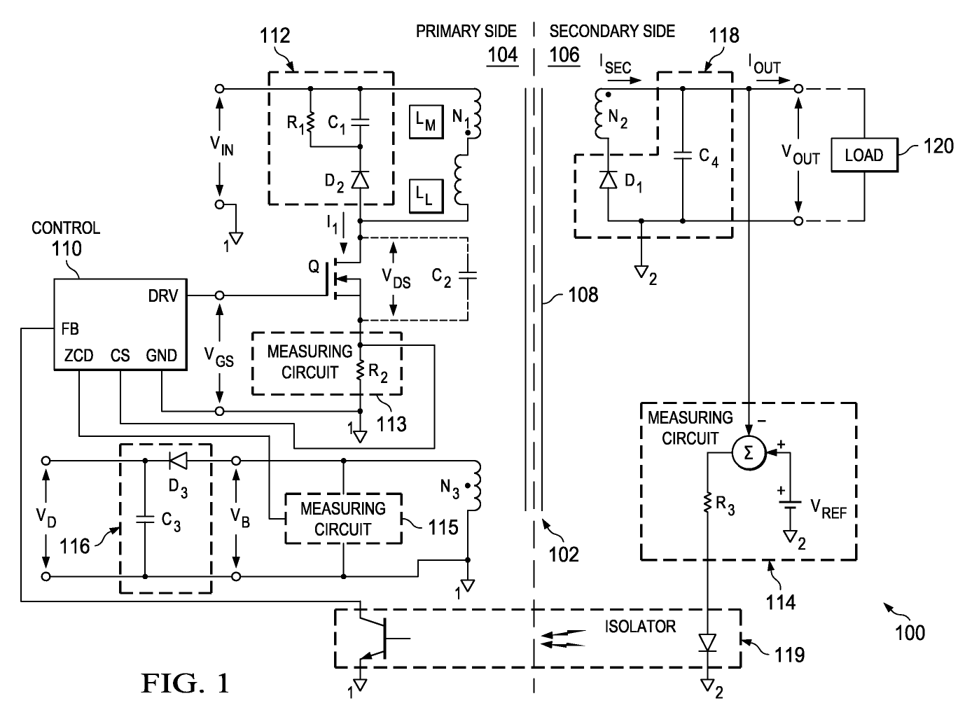

Referring to FIG. 1 of the drawings, the reference numeral 100 generally designates a DCM flyback converter in accordance with an embodiment of the present invention. A central component of the converter 100 is transformer 102. Transformer 102 has a primary side 104 and a secondary side 106. Each of the primary and secondary sides 104 and 106 includes a plurality of inductors N₁, N₂, and N₃ that are magnetically coupled to one another when the transformer is energized. Preferably, the primary side 104 of the transformer 102 has two primary windings or inductors N₁ and N₃, while the secondary side 106 has one secondary winding or inductor N₃. Primary side winding N₁ has a magnetizing inductance L_{M} that is magnetically coupled with inductors N₂ and N₃, and primary side winding N₁ has a leakage inductance L_{L} that is not magnetically coupled to windings N₂ and N₃. The direction of the windings is such that a positive voltage applied between the dotted terminal and non-dotted terminal of any winding N₁, N₂ or N₃ results in voltage appearing at the other windings with the polarity of positive voltage at the dotted terminals, relative to the non-dotted terminal of a winding.

The secondary side 106, as is conventional, outputs an output current I_{OUT} and an output voltage V_{OUT} to a load 120. Specifically, a rectifier 118 (which generally comprises diode D₁ and capacitor C₄) is coupled across the secondary winding or inductor N₂ and receives the secondary side current I_{SEC}. Measuring circuit 114 measures the error between V_{OUT} and V_{REF} then, conveys the information to controller 110 through isolator 119.

Coupled to primary winding N₁ is an Resistor-Capacitor-Diode (RCD) network 112. RCD network 112 is generally comprised of a resistor R, a capacitor C₁, and a diode D₂. Preferably, an input voltage is input between one terminal of the primary winding N₁ and ground. Additionally, resistor R and capacitor C₁ are preferably coupled to the terminal of the primary winding N₁ that receives the input voltage. Diode D₂ is preferably coupled between capacitor C₁ and transformer primary winding N₁. Resistor R is also preferably coupled to the node between the capacitor C₁ and the diode D₂.

Coupled to primary winding N₃ is a rectifier 116. Preferably, rectifier 116 receive a voltage V_{B} and current I_{B} from the winding N₃. The rectifier 116 (which is generally comprised of diode D₃ and capacitor C₃) outputs a voltage V_{D}. This voltage V_{D} is then measured by the measuring circuit 114 and an indicia or measurement of the voltage V_{D} is communicated to the controller 110 (which operates as a means for receiving).

Coupled to the RCD network 112 is a switch Q. Preferably, switch Q is an n-channel enhancement mode n-channel MOSFET that has its body coupled to its source. In particular, switch Q is preferably coupled to the node between the anode of diode D₂ and transformer primary winding N₁ at its drain, and is preferably coupled to measuring circuit 113 at its source that measures current I₁ and allows the switch current to return to the primary common connection and an indicia or measurement of the current I₁ is communicated to the controller 110 (which operates as a means for receiving). Measuring circuit 113 can be implemented as a resistor, as shown in FIG. 1, or a current transformer in either the drain or the source of MOSFET Q, or by any other method. The switch Q generally receives actuation or control signals at its gate from the controller 110 (which operates as a means for actuating). Switch Q also includes a parasitic capacitance C₂.

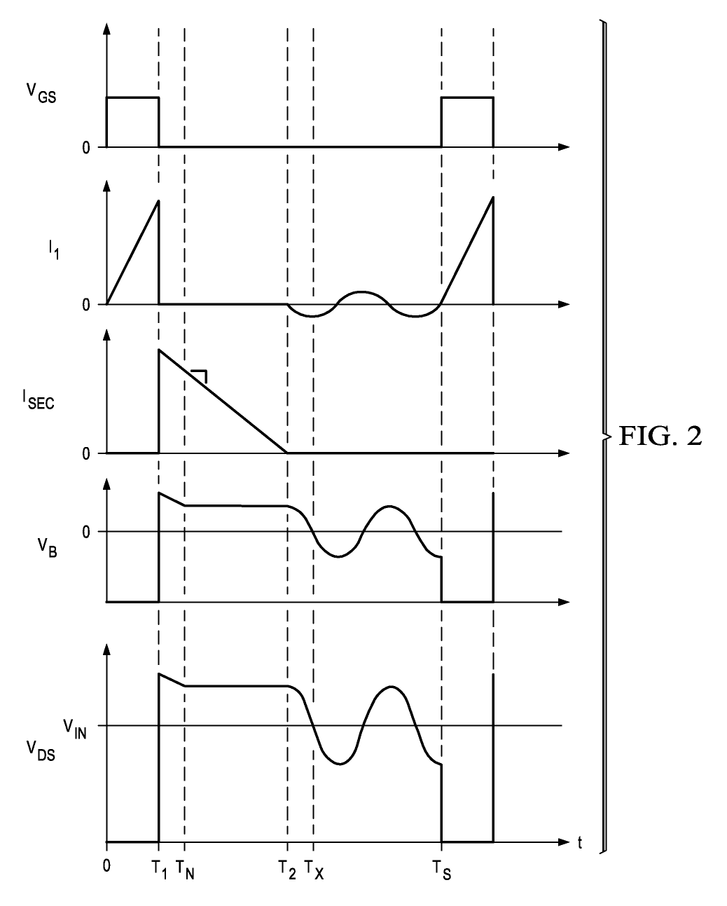

In operation as shown in FIG. 2, the controller 110 generates an actuation signal or gate-source voltage signal V_{GS} to actuate the switch Q, which can be seen in FIG. 2. Because of the configuration of the switch Q, logic high or approximately 5 Volts would correspond to actuation, and the each period or interval for which the gate-source voltage V_{GS} is at logic high are referred to as actuation periods. During actuation periods, the current I₁ through switch Q increases, having an overall energy of about:

$$E \approx \frac{1}{2} {L}_{M} {I}_{1 , p}^{2} \qquad ( 1 )$$

where L_{M} is the magnetizing inductance of transformer winding N₁ and I_{1,p} is the peak of current I₁. Additionally, the drain-source voltage V_{DS} and voltage V_{B} remain generally constant during actuation periods. The energy rate that is processed by converter 100 is set by the error information that is determined by measuring circuit 114 and conveyed to controller 119 through isolator 119.

Upon completion of the actuation, the actuation signal V_{GS} transitions from logic high to logic low (about 0 volts). When this occurs, the transformer 102 is energized or has a standing magnetic field, which then begins to collapse or dissipate. As a result, the secondary current I_{SEC} generally, linearly decreases. Preferably, the rate of change of the secondary current I_{SEC} is about:

$$\frac{d {I}_{SEC}}{d t} \approx - \frac{{N}_{1 , w}^{2} {V}_{OUT}}{{N}_{2 , w}^{2} {L}_{m}} \qquad ( 2 )$$

where L_{M} is the magnetizing inductance of transformer winding N₁, N_{1,w} is the number of turns of winding N₁, and N_{2,w} is the number of turns of winding N₂. Additionally, after the secondary current decays to approximately zero, a resonance period occurs, which is as a result of the LC effect of inductor L_{M} and capacitor C₂.

To generally ensure that the converter 100 operates as desired, the controller 110 spaces the actuation periods apart from one another and the controller 110 generally does not allow actuation periods less than a pre-determined, fixed minimum. In particular, the controller 110 uses the indicia of the voltage V_{FB} to separate an interval that allows energy within the transformer 102 to substantially dissipate. Preferably, the interval is greater that the total time or sum of the time for the secondary current to decay to zero and the resonance period. The controller 110 accomplishes this because the voltage V_{B} crosses 0 (as shown in FIG. 2) at time T_{X}, which can be detected through the use of a comparator and measuring circuit 115. Detection of this crossing would, thus, indicate that the transformer 102 has been de-energized. The controller 110 does not actuate switch Q unless the drain-source voltage V_{DS} has crossed the input voltage V_{IN}. The controller 110 terminates actuation of switch Q if current I₁ has reached the lesser of a level prescribed by the indicia of voltage V_{D} or a fixed maximum level of I_{1,p}.

From the configuration of converter 100, there are also numerous benefits. In particular, the output current under short circuit conditions (across the load 120) is generally limits as follows:

$$1 \approx \frac{1}{2} \frac{{N}_{1 , w}}{{N}_{2 , w}} {I}_{1 , p} \qquad ( 3 )$$

where I_{1,p} is the peak current through switch Q. The average secondary current is limited by the reduction of switching frequency that is imposed by the controller 110 with a requirement that transformer 102 de-energize before allowing the next switch actuation and the fixed minimum actuation period. Practically, this can represent greater than 50% reduction in the current tailing compared to other conventional converters. Additionally, converter 100 can provide additional protection from excessive input current when there is an abnormally low input voltage V_{IN} because the switch current I₁ starts a cycle (just prior to actuation) at zero current.

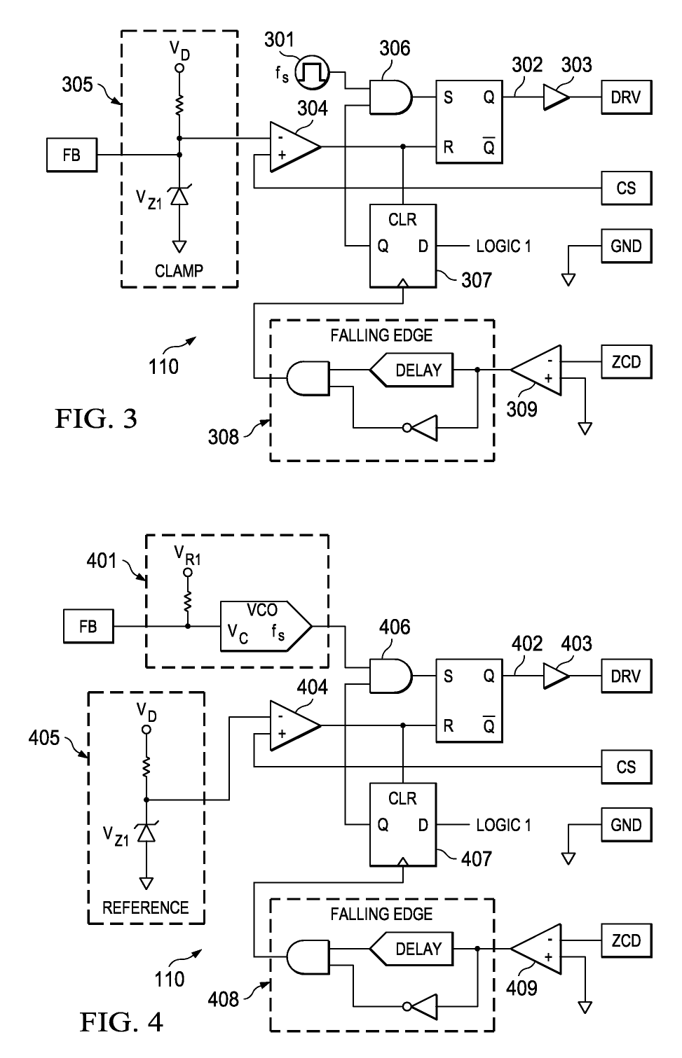

Referring to FIG. 3 of the drawings, an example configuration for controller 110 is shown. Preferably, controller 110 of FIG. 3 is a constant frequency current programmed mode controller with over-current and brown-out protection. Controller 110 of FIG. 3 generally comprise oscillator 301, modulator latch 302, driver 303, switch current comparator 304, clamp 305, logic gate 306, flip-flop 307, falling edge detector 308, and comparator 309. Controller 110 of FIG. 3, preferably, employs logic gate 306, flip-flop 307, falling edge detector 308, and comparator 309 to generally prevent the controller 110 from beginning the next switching cycle until transformer 102 in FIG. 1 is de-energized. Thus, controller 110 as shown in FIG. 3 generally forces converter 100 to operate in Discontinuous Conduction Mode or DCM. Moreover, controller 110 of FIG. 3 generally limits the power that converter 100 can process to a predetermined upper level that is generally defined by the current level that is set by clamp 305, the frequency of oscillator 301, the primary magnetizing inductance, and turn ratio of transformer 102. The average output current of converter 100 is generally limited to twice the output current of 100, measured at peak output power and regulated output voltage. The average input current of converter 100 is generally limited to half of the peak input current that is set by clamp 305 and the gain of measuring circuit 113.

Referring to FIG. 4 of the drawings, another example configuration for controller 110 is shown. Preferably, controller 110 of FIG. 4 is a variable frequency, constant flux controller with over-current and brown-out protection. Controller 110 of FIG. 4 generally comprises Voltage Controlled Oscillator (VCO) 401, modulator latch 402, driver 403, switch current comparator 404, reference 405, logic gate 406, flip-flop 407, falling edge detector 408, and comparator 409. Controller 110 of FIG. 4, preferably, employs logic gate 406, flip-flop 407, falling edge detector 408, and comparator 409 to prevent the controller 110 from beginning the next switching cycle until transformer 102 in FIG. 1 is de-energized. Thus, controller 110 of FIG. 4 generally forces converter 100 to operate in a Discontinuous Conduction Mode. Moreover, controller 110 generally limits the power that converter 100 can process to a predetermined upper level that is defined by reference 405, the predetermined maximum frequency of VCO 401, and the primary magnetizing inductance, and turn ratio of transformer 102. The average output current of converter 100 is generally limited to twice the output current of 100, measured at peak output power and regulated output voltage. The average input current of converter 100 is generally limited to half of the peak input current that is set by reference 405 and the gain of measuring circuit 113.

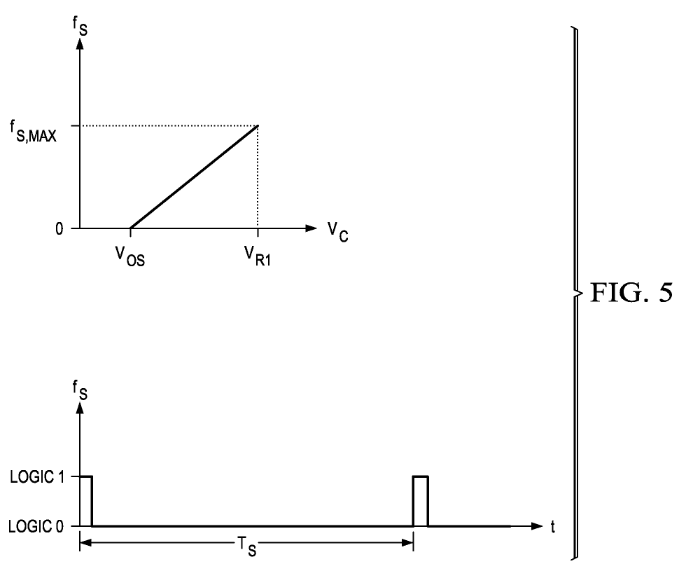

Now turning to FIG. 5, the operation of the VCO 401 is shown. Reference numeral 501 designates the frequency of VCO 401 for the range of FB voltages V_{FB}. The predetermined maximum frequency of VCO 401 occurs when voltage V_{FB} is at an predetermined upper value, V_{R1}. The predetermined minimum frequency for VCO 401 occurs at the predetermined lower level, V_{OS}.

The method to set the predetermined upper power level of converter 100 can be used with constant frequency current programmed mode controllers, as described in FIG. 3 or variable frequency, constant flux controller, as described in FIGS. 4 and 5. For a given converter 100 where the turn ratio of transformer 102 is known, the peak of current I₁ of MOSFET Q in converter 100 is chosen so that the time to energize transformer 102 plus the time to de-energize transformer 102 plus at least one fourth of the resonant cycle of the magnetizing inductance of transformer 102 and stray capacitance C₂ in converter 100 equals the period of the predetermined upper switching frequency that is allowed by controller 110 under the condition that converter 100 is operating at peak output power, V_{OUT} times I_{OUT}, and predetermined lower input voltage V_{IN}. The peak switch current is approximately:

$${I}_{1 , PEAK} = 2 {I}_{OUT , MAX} {V}_{OUT} ( \frac{1}{{V}_{IN , MIN}} + \frac{1}{\frac{{N}_{1}}{{N}_{2}} {V}_{OUT}} ) + \sqrt{\frac{1}{8} {I}_{OUT , MAX} {V}_{OUT} {C}_{2} {f}_{S , MAX}} \qquad ( 4 )$$

The primary inductance of transformer 102 is approximately:

$${L}_{M} ≅ \frac{2 {I}_{OUT , MAX} {V}_{OUT}}{{I}_{1 , PEAK}^{2} {f}_{S , MAX}} \qquad ( 5 )$$

Program the peak current I₁ of MOSFET Q in converter 100 for controllers, such as the examples shown in FIG. 3 and FIG. 4, by selecting the value of current sense resistor R₂ in converter 100.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
a transformer having a primary and a secondary side, wherein the primary side has a first primary winding and a second primary winding, and wherein the secondary side has a secondary winding;
an RCD network coupled to the first primary winding;
a rectifier coupled to the second primary winding;
a measuring circuit coupled to ground;
a switch coupled between the the first primary winding and the measuring circuit, wherein the measuring is adapted to measure current through the switch; and
a controller that receives indicia of a rectified voltage from the rectifier and that controls the actuation of the switch, wherein the controller provides an actuation signal to the switch with actuation periods that are separated from one another by an interval that allows energy within the transformer to substantially dissipate.

2. The apparatus of claim 1, wherein the RCD network further comprises:
a capacitor coupled to a first terminal of the first primary winding;
a diode coupled to the capacitor; and
a resistor coupled to the first terminal and a node between the capacitor and diode.

3. The apparatus of claim 1, wherein the rectifier further comprises:
a diode coupled to the second primary winding; and
a capacitor coupled between the diode and ground.

4. The apparatus of claim 1, wherein the apparatus further comprises a second measuring circuit that is coupled to the rectifier and that provide the indicia of the rectified voltage to the controller.

5. The apparatus of claim 1, wherein the apparatus further comprises a second measuring circuit that is coupled across the second primary winding and that is adapted to provide an indicia of voltage across the second primary winding to the controller.

6. The apparatus of claim 1, wherein the apparatus further comprises a second rectifier coupled to the secondary winding of the secondary side, wherein the second rectifier outputs an output voltage and an output current.

7. The apparatus of claim 6, wherein the interval is greater than a sum of a period of decay of the output current and a resonance period.

8. An apparatus comprising:
a first inductor having a first number of turns;
a second inductor having a second number of turns, wherein the second inductor is adapted to be magnetically coupled to the first inductor;
a third inductor having a third number of turns, wherein the third inductor is adapted to be magnetically coupled to the first and the second inductors;
a capacitor coupled to a first terminal of the first inductor;
a diode coupled between a second terminal of the first inductor and the capacitor;
a resistor coupled to the first terminal of the first inductor and a node between the capacitor and diode;
a rectifier coupled to the second inductor;
a measuring circuit coupled to ground;
a FET coupled between the first inductor and the measuring circuit; and
a controller that receives indicia of a rectified voltage from the rectifier and that controls the actuation of the switch, wherein the controller provides an actuation signal to the switch with actuation periods that are separated from one another by an interval that allows energy within the first, second, and third inductors to substantially dissipate.

9. The apparatus of claim 8, wherein the rectifier further comprises:
a second diode coupled to the second primary winding; and
a capacitor coupled between the second diode and ground.

10. The apparatus of claim 8, wherein the apparatus further comprises a measuring circuit that is coupled to the rectifier and that provide the indicia of the rectified voltage to the controller.

11. The apparatus of claim 8, wherein the apparatus further comprises a second measuring circuit that is coupled across the second inductor and that is adapted to provide an indicia of the voltage across the second inductor to the controller.

12. The apparatus of claim 8, wherein the apparatus further comprises a second rectifier coupled to the third inductor, wherein the second rectifier outputs an output voltage and an output current.

13. The apparatus of claim 12, wherein the interval is greater than a period of decay of the output current and a portion of a resonance period.

14. An apparatus comprising:
a transformer having a primary and a secondary side, wherein the primary side has a first primary winding and a second primary winding, and wherein the secondary side has a secondary winding;
an RCD network coupled to the first primary winding;
a rectifier coupled to the second primary winding;
a measuring circuit coupled to ground;
a switch coupled between the the first primary winding and the measuring circuit, wherein the measuring is adapted to measure current through the switch;
means for receiving indicia of a rectified voltage from the rectifier; and
means for actuating the switch, wherein the means for actuating actuates the switch during periods that are separated from one another by an interval that allows energy within the transformer to substantially dissipate.

15. The apparatus of claim 14, wherein the RCD network further comprises:
a capacitor coupled to a first terminal of the first primary winding;
a diode coupled to the capacitor; and
a resistor coupled to the first terminal of the first primary winding and a node between the capacitor and diode.

16. The apparatus of claim 14, wherein the rectifier further comprises:
a diode coupled to the second primary winding; and
a capacitor coupled between the diode and ground.

17. The apparatus of claim 14, wherein the apparatus further comprises a second rectifier coupled to the secondary winding of the secondary side, wherein the second rectifier outputs an output voltage and an output current.

18. The apparatus of claim 18, wherein the interval is greater than a sum of a period of decay of the output current and a resonance period.
